(19) United States
(12) Patent Application Publication
(10) Pub. No.: US 2012/0029843 A1
(43) Pub. Date: Feb. 2, 2012

(54) METHOD, SYSTEM, AND COMPUTER PROGRAM PRODUCT FOR SENSOR DATA COLLECTION IN A WIND TURBINE

(75) Inventors: Chakradhar Byreddy, Spring, TX (US); Robert Bowyer, Fulham (GB); Ashish Sareen, Sugar Land, TX (US)

(73) Assignee: VESTAS WIND SYSTEMS A/S, Randers SV (DK)

(21) Appl. No.: 12/847,750

(22) Filed: Jul. 30, 2010

(51) Int. Cl. G01L 1/22

(52) U.S. Cl. 702/42

(57) ABSTRACT

Method, system, and computer program product for collecting sensor readings from a component of a wind turbine. The system includes a data collection system coupled in communication with a sensor. The data collection unit includes a processor configured to direct the sensor readings from the sensor to a buffer for temporary storage and to identify a triggering event by comparing the sensor readings received from the sensor with a reference value. In response to the identification of the triggering event, the sensor readings are transferred from the buffer to the mass storage device and stored in a non-volatile form by the mass storage device.

### BACKGROUND

This application relates generally to electrical power generation and, more specifically, to methods, systems, and computer program products for use in collecting sensor data from wind turbine sensors.

Wind turbines can be used to produce electrical energy without the necessity of fossil fuels. Generally, a wind turbine is a rotating machine that converts the kinetic energy of the wind into mechanical energy and the mechanical energy subsequently into electrical power. Common horizontal-axis wind turbines include a tower, a nacelle located at the apex of the tower, and a rotor that is supported in the nacelle by means of a shaft. The shaft couples the rotor either directly or indirectly with a generator housed inside the nacelle. Wind currents cause the rotor to activate the generator to generate electrical power that is ultimately output to a power grid.

A wind turbine includes various sensors that monitor variables associated with components of the wind turbine. Because of the associated burden, communicating sensor readings in real time to an operator or to a storage device is impractical. Typically, the sensor readings acquired over a given time period are averaged or subjected to a root-mean-square (RMS) statistical analysis. The resulting low frequency readings are communicated to the operator or storage device. The statistical analysis reduces the sheer amount of sensor data, which reduces the burden of data collection. However, the concomitant cost is that valuable information regarding the circumstances of undesirable component conditions is forfeited due to the statistical analysis.

Improved methods, systems, and computer program products are needed to improve the collection of sensor data in a wind turbine.

### BRIEF SUMMARY

In an embodiment of the invention, a system is provided for collecting sensor readings from a component of a wind turbine. The system includes a sensor configured to monitor the component and to generate the sensor readings, as well as a data collection system coupled in communication with the sensor. The data collection unit includes a processor, a buffer operatively coupled with the processor, and a mass storage device operatively coupled with the processor. The processor is configured to direct the sensor readings from the sensor to the buffer for temporary storage and to identify a triggering event by comparing the sensor readings with a reference value. In response to the identification of the triggering event, the processor is further configured to cause the sensor readings to be transferred from the buffer to the mass storage device and stored in a non-volatile form by the mass storage device.

In another embodiment of the invention, a computer-implemented method is provided for collecting sensor readings acquired by a sensor monitoring a component of the wind turbine and communicated to a data collection system. The method includes temporarily storing a first number of the sensor readings communicated from the sensor in a buffer of the data collection system, and comparing the sensor readings received from the sensor with a reference value to identify a triggering event for which at least one of the sensor readings exceeds the reference value. In response to the identification of the triggering event, the first number of the sensor readings is transferred from the buffer to a mass storage device of the data collection system for non-volatile storage.

In yet another embodiment of the invention, a computer program product is provided for collecting sensor readings acquired by a sensor monitoring a component of the wind turbine and communicated to a data collection system. The computer program product includes first program instructions for temporarily storing a first number of the sensor readings communicated from the sensor in a buffer of the data collection system, second program instructions for comparing the sensor readings received from the sensor with a reference value to identify a triggering event for which at least one of the sensor readings exceeds the reference value, and third program instructions for transferring the first number of the sensor readings from the buffer to a mass storage device of the data collection system for non-volatile storage in response to the identification of the triggering event. The first, second, and third program instructions are stored on a computer readable storage medium.

### BRIEF DESCRIPTION OF THE SEVERAL VIEWS OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention.

FIG. 1 is a perspective view of a wind turbine that includes a data collection system in accordance with an embodiment of the invention.

FIG. 2 is a perspective view of a portion of the wind turbine of FIG. 1 in which the nacelle is partially broken away to expose structures housed inside the nacelle.

FIG. 3 is a diagrammatic view of the data collection system of FIG. 1.

FIG. 4 is a diagrammatic view of a display viewable by an operator of the wind turbine and on which are displayed variables computed by the data collection system.

FIG. 5 is a flow chart of sensor data collection in accordance with an embodiment of the invention.

### DETAILED DESCRIPTION

The embodiments of the invention relate to the concept of using an event-based trigger to capture high frequency sensor data of a physical condition or a physical property of a wind turbine component. When an undesirable event occurs, the amount of collected sensor data is maximized. For example, during a buffer period of arbitrary duration, a large number of readings from one or more sensors is recorded and stored in a buffer. The recorded data may be captured over the duration of the buffer period using sensors and/or optical strain gauges associated with the rotor blades, the tower, the nacelle, etc. The trigger for the high speed or high frequency data acquisition may be a predefined triggering event, such as the sensor reading reaching a set value or the achievement of a threshold sensor reading. Alternatively, the high frequency sensor data may be acquired at the discretion of a wind turbine operator. The high frequency sensor data is recorded and stored in a mass storage device, such as a hard drive, that may be located at the bottom of the wind turbine tower.

The sensor data stored in the mass storage device is then analyzed and/or processed by, for example, fast Fourier transform (FFT), spectrum density analysis, etc. Once analyzed, a variable computed from the high frequency sensor data is relayed to an operator in real time for the representative purposes of operational guidance. The presentation of the high frequency sensor data to the operator on a real-time basis creates a real-time advisor that draws the operator's attention on an existing problem occurring at the wind turbine. The operator can then decide either to stop the wind turbine or to continue to run the wind turbine. If the operator, despite the warning from the presentation of the variable computed from the high frequency sensor data, decides to continue running the wind turbine, the recorded data may be optionally used by a manufacturer of the wind turbine to exclude warranty.

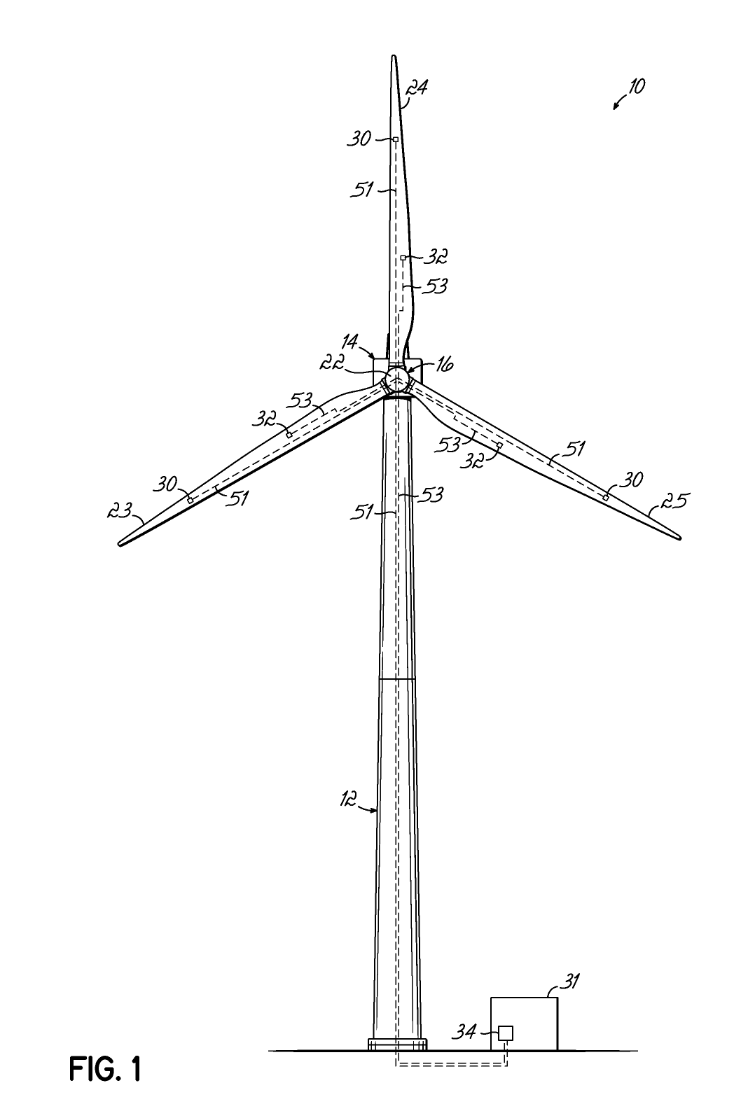

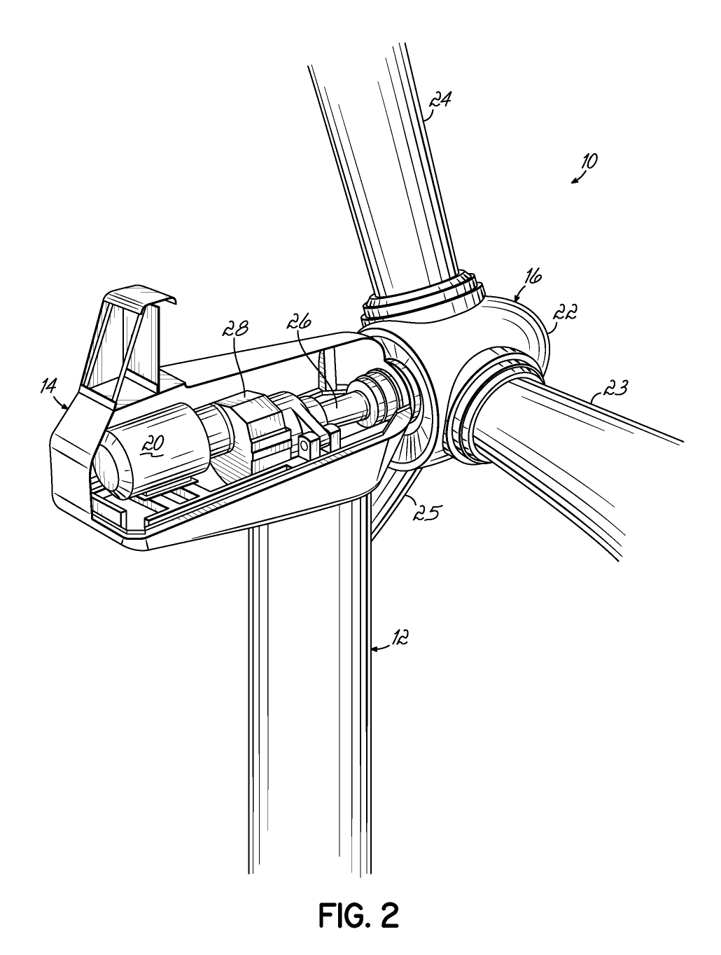

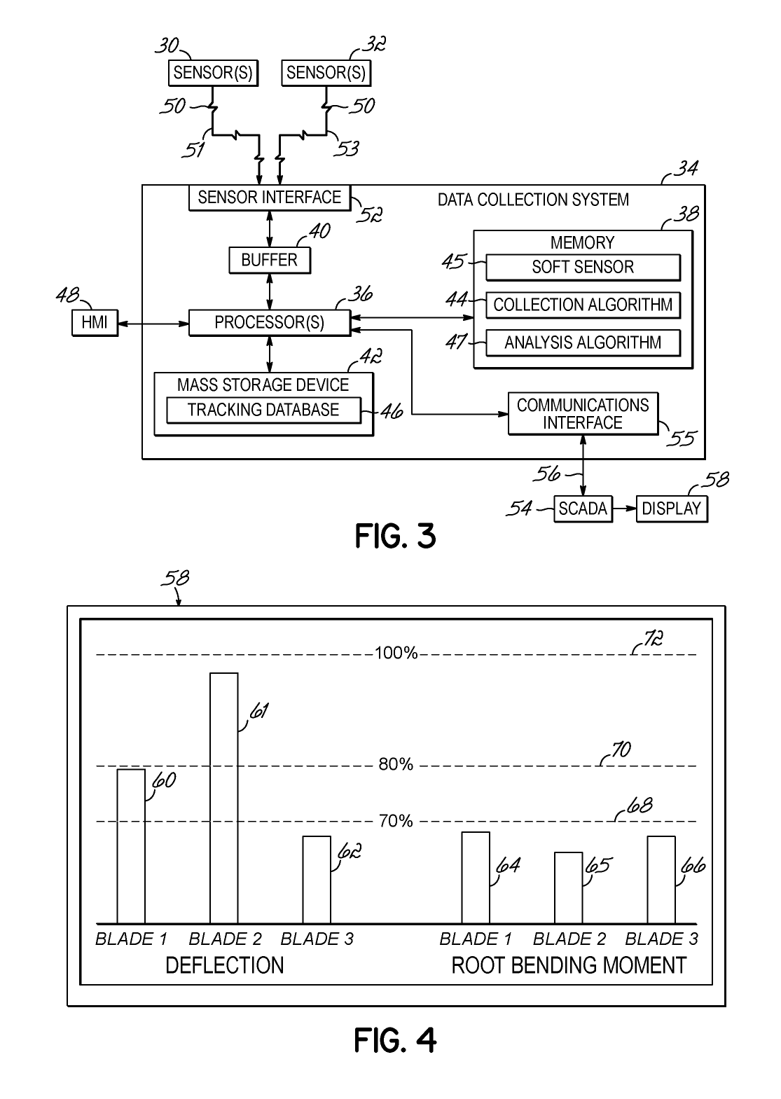

With reference to FIGS. 1 and 2 and in accordance with an embodiment of the invention, a wind turbine 10, which is depicted as a horizontal-axis machine, includes a tower 12, a nacelle 14 disposed at the apex of the tower 12, and a rotor 16 operatively coupled to a generator 20 housed inside the nacelle 14. In addition to the generator 20, the nacelle 14 houses miscellaneous components required for converting wind energy into electrical energy and various components needed to operate, control, and optimize the performance of the wind turbine 10. The tower 12 supports the load presented by the nacelle 14, the rotor 16, and other components of the wind turbine 10 that are housed inside the nacelle 14 on an underlying foundation. The tower 12 of the wind turbine 10 also operates to elevate the nacelle 14 and rotor 16 to a height above ground level or sea level, as may be the case, at which faster moving air currents of lower turbulence are typically found.

The rotor 16 includes a central hub 22 and a plurality of blades 24 attached to the central hub 22 at locations circumferentially distributed about the central hub 22. In the representative embodiment, the rotor 16 includes three blades 23, 24, 25 but the number may vary. The blades 23, 24, 25, which project radially outward from the central hub 22, are configured to interact with the passing air currents to produce lift that causes the central hub 22 to spin about a longitudinal axis. The design, construction, and operation of the blades 23, 24, 25 are familiar to a person having ordinary skill in the art. For example, each of the blades 23, 24, 25 is connected to the central hub 22 through a pitch mechanism that allows the blade to pitch under control of a pitch controller. The nacelle 14 and rotor 16 are coupled by a bearing with the tower 12 and a yaw orientation system is used to maintain the rotor 16 aligned with the wind direction.

A low-speed drive shaft 26 is mechanically coupled with the central hub 22 of the rotor 16. The drive shaft 26 is mechanically coupled by a gearbox 28 with a rotor assembly of the generator 20. The gearbox 28 relies on gear ratios in a drive train to provide speed and torque conversions from the rotation of the rotor 16 to the rotor assembly of the generator 20. Alternatively, the low-speed drive shaft 26 may directly connect the central hub 22 of the rotor 16 with a rotor assembly of the generator 20 so that rotation of the central hub 22 directly drives the rotor assembly to spin relative to a stator assembly of the generator 20. The generator 20 may be any type of synchronous generator or asynchronous generator as understood by a person having ordinary skill in the art.

Wind exceeding a minimum level will activate the rotor 16 and cause the rotor 16 to rotate in a substantially perpendicular direction to the wind. The relative motion of the rotor and stator assemblies of generator 20 functionally converts the mechanical energy supplied from the rotor 16 into electrical power so that the kinetic energy of the wind is harnessed by the wind turbine 10 for power generation. Under normal circumstances, the electrical power is supplied as three-phase alternating current (AC) to a power grid as known to a person having ordinary skill in the art.

The wind turbine 10 may belong to a wind farm or wind park that includes a plurality of wind turbines each similar or identical to the representative wind turbine 10. The wind farm acts as a generating plant ultimately interconnected by transmission lines with the power grid, which may be a three-phase power grid and generally consists of a distribution network of power stations, transmission circuits, and substations coupled by a network of transmission lines.

Sensors 30, 32 are stationed at different locations within the components of the wind turbine 10. In the representative embodiment, each sensor 30 is configured to measure a first physical condition or physical property respectively associated with each of the blades 23, 24, 25 and generate raw sensor readings based upon the measured first physical condition or physical property. Each sensor 32 is configured to measure a second physical condition or physical property respectively associated with each of the blades 23, 24, 25 and generate raw sensor readings based upon the measured second physical condition or physical property. The sensor readings are preferably acquired during the operation of the wind turbine 10. In the representative embodiment, each sensor 30 may be configured to acquire raw sensor data that reflects displacement or deflection of the respective one of the blades 23, 24, 25 and each sensor 32 may be configured to acquire raw sensor data that reflects root bending moments of the respective one of the blades 23, 24, 25. Suitable constructions for the sensors 30, 32 are known to a person having ordinary skill in the art. The sensors 30, 32 may have, but are not limited to having, the construction of optical strain gauges that are rigidly mounted to each of the blades 23, 24, 25.

The wind turbine 10 also includes a data collection system 34 that is coupled or connected in communication with the sensors 32, 34. The data collection system 34 is configured to collect raw sensor readings originating from the sensors 30, 32 in a manner consistent with the embodiments of the invention. While the sensors 30, 32 are located up-tower, the data collection system 34 has a down-tower location. In the representative embodiment, an enclosure 31 near the base of tower 12 houses the data collection system 34. However, it is understood that the data collection system 34 may have a different down-tower location, such as a central location for multiple collection systems each similar or identical to data collection system 34 and that service other wind turbines in a wind farm.

The data collection system 34 can be implemented using one or more processors 36 selected from microprocessors, micro-controllers, microcomputers, digital signal processors, central processing units, field programmable gate arrays, programmable logic devices, state machines, logic circuits, analog circuits, digital circuits, and/or any other devices that manipulate signals (analog and/or digital) based on operational instructions that are stored in a memory 38. The data collection system 34 also includes a buffer 40 that receives and dynamically stores a limited amount of data in the form of sensor readings received from the sensors 30, 32, as well as a mass storage device 42 with a data capacity appropriate for long term storage of information including the raw sensor readings and the variables computed from the raw sensor readings as discussed herein.

The memory 38 may be a single memory device or a plurality of memory devices including but not limited to random access memory (RAM), volatile memory, non-volatile memory, static random access memory (SRAM), dynamic random access memory (DRAM), flash memory, cache memory, and/or any other device capable of storing digital information. The mass storage device 42 may include one or more hard disk drives, floppy or other removable disk drives, direct access storage devices (DASD), optical drives (e.g., a CD drive, a DVD drive, etc.), and/or tape drives, among others. The buffer 40 is a region of memory in, for example, memory 38 and/or mass storage device 42 that temporarily holds the sensor readings received from the sensors 30, 32. A holding area of limited capacity is allocated in the buffer for the sensor readings received from each of the sensors 30, 32. The data is systematically stored in the buffer 40 upon receipt of the sensor readings from each of the sensors 30, 32. However, the data is only output from the buffer 40 and copied to the mass storage device 42 in reaction to a triggering event.

The processor 36 of data collection system 34 operates under the control of an operating system, and executes or otherwise relies upon computer program code embodied in various computer software applications, components, programs, objects, modules, data structures, etc. and that contains instructions for acquiring, storing, and computationally analyzing the sensor readings from the sensors 30, 32. The computer program code residing in memory 38 and stored in the mass storage device 42 also includes a collection algorithm 44 that, when executing on the processor, reacts to a perceived event to transfer sensor data from the buffer 40 to a tracking database 46 in the mass storage device 42. The computer program code residing in memory 38 also includes an analysis algorithm 47 that operates on the stored sensor data using a fast Fourier transform (FFT), a spectral density analysis, etc. The computer program code typically comprises one or more instructions that are resident at various times in memory 38, and that, when read and executed by processor 36, causes the data collection system 34 to perform the steps necessary to execute steps or elements embodying the various embodiments and aspects of the invention. Archival copies of the computer program code may be stored in the mass storage device 42.

Various program code described herein may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

A human machine interface (HMI) 48 of the data collection system 34 is operatively connected to the processor 36 in a conventional manner. The HMI 48 may include output devices, such as alphanumeric displays, a touch screen, and other visual indicators, and input devices and controls, such as an alphanumeric keyboard, a pointing device, keypads, pushbuttons, control knobs, etc., capable of accepting commands or input from the operator and transmitting the entered input to the processor 36.

Signals 50 containing raw sensor readings are communicated from the sensors 30, 32 to a sensor interface 52 at the data collection system 34. The sensor interface 52 is any type of known interface that allows the data collection system 34 to communicate with the sensors 30, 32 and that may be operatively coupled with the sensors 30, 32 of each of the blades 23, 24, 25. Sensor interface 52 may include, for example, one or more analog-to-digital converters that convert analog signals 50 communicated from the sensors 30, 32 into digital signals that can be used by processor 36.

Sensors 30, 32 for each of the blades 23, 24, 25 may communicate the signals 50 over communications links 51, 53, such as electrical conductors (wires) or optical fibers, with the sensor interface 52 at the data collection system 34 and/or in wireless communication over the communications links 51, 53 with the sensor interface 52 at the data collection system 34. If the communications links 51, 53 are wired using electrical conductors, the sensors 30, 32 may receive power from the data collection system 34. If the data collection system 34 is constructed with a wireless configuration, the sensors 30, 32 may be powered by a battery and the sensors 30, 32 and sensor interface 52 will include transceivers enabling the wireless communications.

The signals 50 originating from the sensors 30, 32 can also be provided to a turbine controller (not shown) for use in controlling the operation of wind turbine 10. In one embodiment, the turbine controller for wind turbine 10 may subsume the sensor data collection functions of the data collection system 34 in an integrated controller scheme.

The buffer 40 is configured with a space allocated to hold a predefined amount of sensor data received from each of the sensors 30, 32 through the sensor interface 52. For example, for each of the sensors 30, 32, the buffer 40 can hold an allocation of sensor readings acquired over a predefined amount of time (e.g., ten minutes, an hour, etc.) or, as another example, may hold an allocation of sensor readings given by a predefined numerical value (e.g., 100 readings, 1000 readings). The sensor data maintained in the buffer 40 is recorded at a high frequency for the sensor readings and the sensor readings are chronologically ordered with newer readings replacing discarded sensor readings that are older. As a result, the raw sensor readings contained in the buffer 40 are acquired and recorded contemporaneous with the operation of the wind turbine 10 and, therefore, inherently have an age limit.

Upon the occurrence of a predefined triggering event recognized by the collection algorithm 44 executing on the processor 36, the high frequency sensor readings in the buffer 40 for the sensors 30, 32 may be copied or otherwise transferred to the mass storage device 42 and stored as data entries in the tracking database 46. More specifically, the data collection system 34 reacts by copying or transferring the raw sensor readings residing in the buffer 40 to a tracking database 46 in the mass storage device 42. This data copy or transfer process occurs without any type of statistical calculation or aggregation.

The triggering event may be specified by comparing the instantaneous raw sensor readings arriving from the sensors 30, 32 with a reference value for the respective sensor readings. The reference value may be present in the memory 38 for access by the collection algorithm 44 and/or may be stored in the mass storage device 42. The predefined triggering event may occur if the instantaneous sensor reading received from one of the sensors 30, 32 exceeds a set numerical value for the sensor reading representing the reference value or may occur if the instantaneous sensor reading received from one or more of the sensors 30, 32 exceeds a numerical threshold for the sensor reading representing the reference value. The conclusion of a triggering event occurs when the instantaneous sensor reading(s) from the sensor(s) 30, 32 that initiated the triggering event drop below the reference value.

Although described herein in terms of the triggering event causing the transfer of sensor readings for all sensors 30, 32 from the buffer 40 into the mass storage device 42, the buffer content for less than all of the sensor readings may be transferred upon recognition or identification of a triggering event. For example, a triggering event detected from the sensor 30 associated with blade 23 may prompt the transfer of only those sensor readings for sensors 30, 32 from the buffer 40 to the mass storage device 42. Multiple additional combinations of the triggering event source and the extent of the sensor readings transferred from the buffer 40 are possible. A time and date stamp may be associated with the sensor readings stored by the tracking database 46 in the mass storage device 42.

Alternatively, instead of triggering data transfer based upon the instantaneous sensor readings from one or more of the sensors 30, 32, the triggering event may be an instruction or command received as a prompt from an operator of the wind turbine 10. Specifically, the memory 38 can hold instructions for the processor 36, upon receipt of an instruction or command from the operator of the wind turbine 10, to initiate the transfer of sensor readings from the buffer 40 to the tracking database 46 in the mass storage device 42.

The mass storage device 42 is a non-volatile storage device of relatively large data capacity for which the sensor readings are preserved when the device is unpowered. On the other hand, the buffer 40 is a temporary storage device of limited data capacity to which the sensor readings are written up to the allocated capacity in the buffer 40 for the sensor readings from each of the sensors 30, 32. A person having ordinary skill in the art will appreciate that the sensor readings may be stored and organized in another type of data structure for tracking purposes instead of a database like the tracking database 46.

The raw high frequency sensor data stored in the tracking database 46 is analyzed and/or processed by the analysis algorithm 47 executing on the processor 36 of the data collection system 34. For example, the analysis algorithm 47 may rely on a fast Fourier transform (FFT), spectral density analysis, etc., to compute a variable from the high frequency sensor readings originating from one or more of the sensors 30 and stored in tracking database 46 and/or another variable from the high frequency sensor readings originating from one or more of the sensors 32 and stored in tracking database 46. In the representative embodiment, blade deflections for each of the blades 23, 24, 25 are variables computed by the processor 36 from the high frequency sensor readings acquired by sensors 30 and recorded as data in the tracking database 46, and root bending moments for each of the blades 23, 24, 25 are variables computed by the processor 36 from the high frequency sensor readings acquired by sensors 32 and recorded as data in the tracking database 46.

The data collection system 34 includes a communications interface 55 that is coupled or connected in communication over a communications link 56 with a supervisory control and data acquisition (SCADA) control system 54. The SCADA control system 54 is also configured to monitor and provide supervisory level control over the wind turbine 10, as well as other wind turbines in the wind farm. In one embodiment, the communications link 56 may be any appropriate wired connection (e.g., universal serial bus communications, an IEEE 1394 interface, a networking standard like IEEE 802.3 Ethernet, serial signaling standards like RS-232 or RS-485, data acquisition input/output boards, etc.) that relies on electrical conductors, wires, or cables extending from the data collection system 34 to the SCADA control system 54 to establish a communication pathway for data and control signals. In another embodiment, the communications link 56 may be any appropriate wireless connection or communications protocol (e.g., IEEE 802.11 standard (WiFi), Bluetooth®, infrared, radio frequency, etc.) in which electromagnetic waves carry data and control signals over all or part of the communication pathway between the data collection system 34 and SCADA control system 54.

The SCADA control system 54 is configured to receive the variables computed from the high frequency sensor data by the data collection system 34 and communicated over the communications link 56 from the data collection system 34. The variables are presented by the SCADA control system 54 to an operator in real time or near real time so that the operator can make real time or near real time decisions based upon the presentation. For example, the variables can provide operational guidance to the operator relating to an existing problem at the wind turbine 10. When presented with the analyzed high frequency sensor data, the operator can decide either to halt the operation of the wind turbine 10 or, alternatively, can decide to continue to run the wind turbine 10. If the operator, despite the warning, decides to continue running the wind turbine 10, the high frequency sensor readings recorded and stored as data on the mass storage device 42 may be optionally used by the manufacturer of the wind turbine 10 for warranty exclusions based upon the operator's actions.

In one embodiment, the variables computed from the high frequency sensor data may be visually displayed to the operator on a display 58. The display 58 may be a segmented LED display, LCD display, or other type of display construction as is known in the art. The variables may be displayed to the operator on the display 58 as in a bar graph form (e.g., a bar graph showing with bar segments characterized by a height proportional to the sensor reading). Alternatively, each of the variables may be numerically displayed to the operator on the display 58 as a percentage of a threshold, for example, of unsafe operation. The operator, in response, has the option to adjust the operation of the wind turbine 10 by, for example, halting the operation of the wind turbine 10 or to continue to permit the wind turbine 10 to operate with the component experiencing a physical effect detected by the high frequency sensor readings that is out of compliance with a safety margin for the variable.

In the representative embodiment, the variable computed from the sensor readings acquired by the sensors 30 is presented on display 58 as a series of bars 60, 61, 62 for blades 23, 24, 25, respectively, and the variable computed from the sensor readings acquired by the sensors 32 is presented to the operator on display 58 as a series of bars 64, 65, 66 for blades 23, 24, 25, respectively. The height of each of the bars 60-62, 64-66 reflects the values of the variable transferred from the data collection system 34. For example, bars 60-62 may represent the respective deflections of the blades 23, 24, 25 following the occurrence of a triggering event and bars 64-66 may represent the respective root bending moments of the blades 23, 24, 25 following the occurrence of a triggering event.

Operational thresholds for the variables may be displayed on the display 58 to provide the operator with further operational guidance. Specifically, a threshold 68 of each variable for safe operation, a threshold 70 of each variable for marginally-safe operation, and a threshold 72 of each variable for unsafe operation may be indicated on the display 58 for the variable measured by each of the sensors 30, 32. The thresholds 68, 70, 72 may be established empirically and specify various ranges of each variable for safe, marginally safe, and unsafe operation. Armed with the information displayed on the display 58, the operator can readily react to the occurrence of undesirable events happening at the wind turbine 10.

A person having ordinary skill in the art will appreciate that additional variables derived from the sensor readings acquired by sensors 30, 32 and/or by additional sensors may be displayed on the display 58. While the thresholds 68, 70, 72 are depicted in the representative embodiment as being identical for the two variables, a person having ordinary skill in the art will comprehend that the thresholds 68, 70, 72 may differ for each variable displayed on display 58.

In the representative embodiment, the height of bar 60 is localized within a marginally-safe operating region between the safe and marginally-safe operation thresholds 68, 70 and the height of bar 61 is localized within an unsafe operating region between the marginally-safe and unsafe operation thresholds 70, 72. Bars 62 and 64-66 have a height below the safe operation threshold 68 and within a safe operating region. An operator can consider the heights of bars 60, 61 and, in response to the graphical presentation of this information, has the discretion to either continue or halt operation of the wind turbine 10.

In addition to the visual manifestation on the display 58, an acoustic and/or visual warning signal may also be generated if, for example, any of the bars 60-62, 64-66 reaches or exceeds the unsafe operation threshold 72. The sound or visibility of the warning signal may be used to attract the operator's attention to the information on the display 58.

As used herein, real time refers to the presentation to an operator of the variable computed from the high frequency sensor data at a substantially short period after the occurrence of a triggering event recognized by the data collection system 34. Events occurring in real time occur without substantial intentional delay. In contrast, as used herein, near real time refers to the presentation to an operator of the variable computed from the high frequency sensor data with some delay after the occurrence of a triggering event. The delay may be intentional, such as due to a timer to permit accumulation of the high frequency sensor readings from initiation of the triggering event to conclusion of data collection, or may be unintentional, such as due to latency for communications or due to time consumed by computations.

In the representative embodiment, the monitored components of the wind turbine 10 are the blades 23, 24, 25 and the sensors 30, 32 measure displacement, loads, one or more components of stress, and/or one or more components of strain experienced by the blades 23, 24, 25 of rotor 16. However, the sensors 30, 32 may be used to monitor one or more of these physical properties occurring at different wind turbine components, such as the tower 12 or the drive shaft 26. Alternatively, the sensors 30, 32 may be vibration sensors, such as accelerometers, providing readings of vibrations measured in rotating components such as the gearbox 28, the main bearing supporting the drive shaft 26, and the generator 20. In each instance, each sensor is configured to measure a physical condition or a physical property of the monitored component of the wind turbine 10.

A person having ordinary skill in the art will appreciate that the sensors 30, 32 may comprise other types of sensors and that these different types of sensors may be monitored using the data collection system 34 at the wind turbine 10 as described herein. Specifically, the sensors 30, 32 may measure other physical conditions or physical properties such as speed, temperature, position, electrical characteristics, and fluid flow variables in or associated with one or more of the components of the wind turbine 10. The sensors 30, 32 are positioned within the wind turbine 10 according to their function. In the representative embodiment, the sensors 30, 32 are positioned on the interior of the blades 23, 24, 25 for measuring strain components.

In an alternative embodiment, the data collection system 34 may also rely on a virtual or soft sensor 45 represented by software in the form of an algorithm residing in the memory 38 and executing on the processor 36. The soft sensor 45 may be implemented by using one or more process models with error correction capabilities. The process models are used in the soft sensor 45 to generate values of one or more soft variables, which are not directly measured, based on sensor readings originating from one or more physical sensors. In the representative embodiment, the virtual sensor 45 is configured to utilize the high frequency sensor readings acquired by sensors 30, 32 as inputs measurements to the algorithm implementing the soft sensor 45. The interactions between the sensor readings from the plural sensors 30, 32 may be used by the soft sensor 45 to calculate values for one or more soft variables.

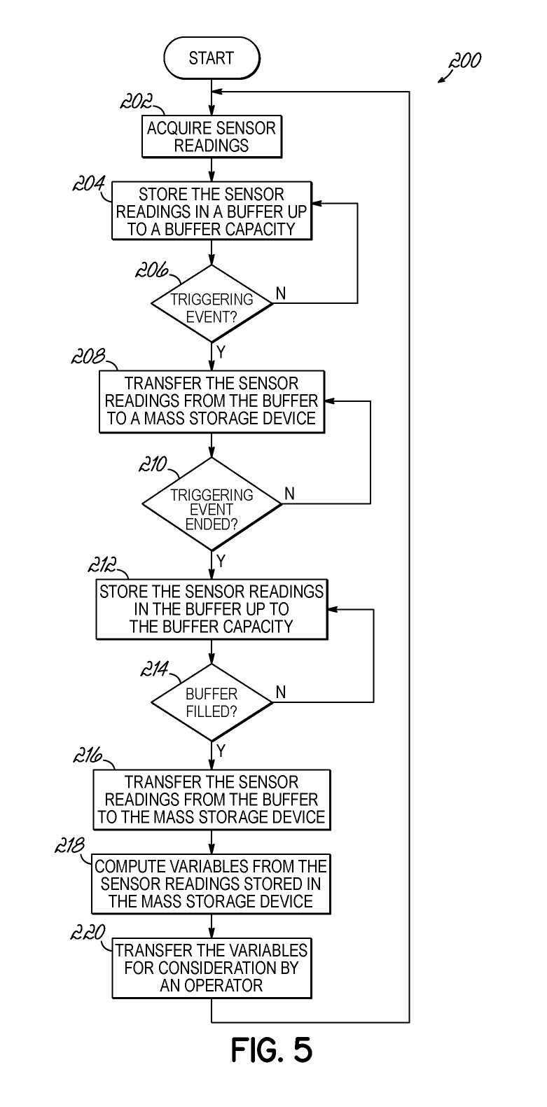

FIG. 5 shows a flowchart 200 illustrating a sequence of operations for the data collection system 34 to capture sensor readings measured by the sensors 30, 32 consistent with embodiments of the invention. In particular, the data collection system 34 monitors the signals 50 arriving as sensor readings from sensors 30, 32 (block 202). In particular, the sensors 30, 32 measure a physical condition or physical property of each of the blades 23, 24, and supplies readings as respective continuous streams of signals 50 to the sensor interface 52 at the data collection system 34. The processor 36 causes the sensor readings to be directed to the buffer 40 for temporary storage within the prescribed capacity limit (block 204).

In block 206, the collection algorithm 44 executing on the processor 36 of data collection system 34 monitors the sensor readings of each sensor 30, 32 for the occurrence of a predefined triggering event satisfied by one or more of the instantaneous raw sensor readings exceeding a predefined reference value. If the processor 36 fails to perceive a triggering event, then the processor 36 decides to not transfer the contents of the buffer 40 to the tracking database 46 in the mass storage device 42 (“No” branch of decision block 206) and the sequence of operations returns back to block 202 for the collection of more sensor data in the buffer 40 within the allocated capacity of each individual group of sensor readings. However, when the processor 36 detects a triggering event (“Yes” branch of decision block 206) for one or more of the sensors 30, 32, then the processor 36 causes the contents of the buffer 40 to be copied or transferred to the tracking database 46 in the mass storage device 42 (block 208) as time-correlated sensor data. In the representative embodiment, the sensor readings in the buffer 40 for both sensors 30, 32 on each of the blades 23, 24, 25 are copied or transferred from the buffer 40 to the tracking database 46.

Control proceeds to block 210 in which the processor 36 directs the sensor readings from sensors 30, 32 into the tracking database 46 while the triggering event is continuing to occur (“No” branch of decision block 210). The sensor readings can be stored in the buffer 40 up to the capacity allocated to each group of sensor readings and copied or transferred as a data block to the tracking database 46, or the processor 36 can bypass the buffer 40 and directly communicate the sensor readings during this transient period from sensors 30, 32 to the tracking database 46. However, if the processor 36 decides that the triggering event has ended due to one or more instantaneous raw sensor readings below the reference value for the triggering event (“Yes” branch of decision block 210), then the processor 36 again causes the sensor readings from sensors 30, 32 to be directed to the buffer 40 for accumulation (block 212). These sensor readings, which reflect values of the measured physical condition or physical property immediately following the conclusion of the undesirable condition causing the triggering event, are stored for each of the sensors 30, 32 up to the capacity limit allocated in the buffer 40 for each group of sensor readings (“No” branch of decision block 214). When the allocated space in the buffer 40 for each group of sensor readings is filled, the processor 36 causes the contents of the buffer 40 to be copied or transferred to the tracking database 46 in the mass storage device 42 (block 216).

The processor 36 analyzes the sensor readings stored in the tracking database 46 to compute one or more variables relating to the physical conditions or physical properties monitored by the sensors 30, 32 (block 218). The variable(s) analyzed or computed from sensor readings are eventually transferred to the SCADA control system 54 (block 220). In one embodiment, the computed variables are presented to an operator at the location of the SCADA control system 54 for decision-making in real time or near real time by, for example, considering the height of bars 60-62, 64-66 presented on the display 58 (FIG. 4).

The sequence of operations in flowchart 200 then returns to block 202 to await another triggering event prompting the collection of high frequency sensor data from the sensors 30, 32.

The high frequency sensor readings, which are based on various undesirable events, that is stored as data in the tracking database 46 can be analyzed offline in non-real time for the wind turbine 10 for purposes of product reliability assessment. For example, the stored high frequency sensor data may be useful to gain an understanding of the deterioration process of a component element of the wind turbine, such as breakage of a blade or pitch bearing failures, to the occurrence of extreme events. The stored sensor readings will typically result from represent multiple undesirable events occurring over time so that the data has a historical significance. These evaluations of historical data may be used to examine events design or manufacturing deficiencies, etc. The high frequency sensor data may also be evaluated for multiple wind turbines in a given wind farm.

The knowledge gained from the high frequency sensor data may be leveraged during component design by recognizing the high frequency sensor data in mathematical models. For example, blades may be designed with reliance upon a more realistic loading spectrum captured from real captured data and, as a result, the design may be refined. Different extreme events can be correlated with various types of equipment failures, thereby reducing the extent of computer integrated manufacturing (CIM) efforts needed to analyze an observed problem. For example, the analyzed sensor data can be input into simulation codes designing new wind turbines or analyzing existing wind turbines, such as the Flex software package, into order to specify new component designs or to refine existing component designs.

The sensor readings in the tracking database 46 can be correlated with other types of information, such as environmental conditions recorded at the site of the wind turbine 10 contemporaneous with the acquisition of the sensor readings and also potentially recorded in the tracking database 46. For example, the high frequency sensor data may be correlated with one or more environmental conditions such as wind velocity, wind gusts, air humidity, air temperature, atmospheric pressure, etc.

As will be appreciated by one skilled in the art, the embodiments of the invention may also be embodied in a computer program product embodied in at least one computer readable storage medium having non-transitory computer readable program code embodied thereon. The computer readable storage medium may be an electronic, magnetic, optical, electromagnetic, infrared, or semiconductor system, apparatus, or device, or any suitable combination thereof, that can contain, or store a program for use by or in connection with an instruction execution system, apparatus, or device. Exemplary computer readable storage medium include, but are not limited to, a hard disk, a floppy disk, a random access memory, a read-only memory, an erasable programmable read-only memory, a flash memory, a portable compact disc read-only memory, an optical storage device, a magnetic storage device, or any suitable combination thereof. Computer program code containing instructions for directing a processor to function in a particular manner to carry out operations for the embodiments of the present invention may be written in one or more object oriented and procedural programming languages. The computer program code may supplied from the computer readable storage medium to the processor of any type of computer, such as the processor 36 of the data collection system 34, to produce a machine with a processor that executes the instructions to implement the functions/acts of a computer implemented process for sensor data collection specified herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “composed of” or variants thereof are used in either the detailed description or the claims, such terms are intended to be inclusive in a manner similar to the term “comprising.”

While the invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative methods, and illustrative examples shown and described. Accordingly, departures may be made from such details without departing from the spirit or scope of applicant's general inventive concept.

What is claimed is:

1. A system for collecting sensor readings from a component of a wind turbine, the system comprising:
a sensor configured to monitor the component and to generate the sensor readings; and
a data collection system coupled in communication with the sensor, the data collection unit including a processor, a buffer operatively coupled with the processor, and a mass storage device operatively coupled with the processor, the processor configured to direct the sensor readings from the sensor to the buffer for temporary storage and configured to identify a triggering event by comparing the sensor readings with a reference value, and the processor further configured to cause the sensor readings to be transferred from the buffer to the mass storage device and stored by the mass storage device in a non-volatile form in response to the identification of the triggering event.

2. The system of claim 1 wherein the processor of the data collection system stores the sensor readings in a tracking database in the mass storage device of the data collection system and is configured to compute a variable from the sensor readings stored in the tracking database.

3. The system of claim 2 wherein the processor of the data collection system is configured to cause the variable to be transferred to a supervisory control system for the wind turbine.

4. The system of claim 1 wherein the sensor is a strain gauge, the component is a rotor blade of the wind turbine, and the sensor readings are related to a change in a strain component experienced by the rotor blade.

5. The system of claim 1 wherein the data collection system includes a soft sensor configured to compute a variable based upon the sensor readings from the sensor.

6. A computer-implemented method for collecting sensor readings acquired by a sensor monitoring a component of the wind turbine and communicated to a data collection system, the method comprising:
temporarily storing a first number of the sensor readings communicated from the sensor in a buffer of the data collection system;
comparing the sensor readings received from the sensor with a reference value to identify a triggering event for which at least one of the sensor readings exceeds the reference value; and
in response to the identification of the triggering event, transferring the first number of the sensor readings from the buffer to a mass storage device of the data collection system for non-volatile storage.

7. The method of claim 6 further comprising using an algorithm executing on the data collection system to compute a variable from the first number of the sensor readings stored in the mass storage device.

8. The method of claim 7 further comprising:
causing the data collection system to communicate the variable to a supervisory controller; and
presenting the variable to an operator of the wind turbine.

9. The method of claim 8 wherein the variable is presented to the operator in real time or near real time relative to the triggering event so that the operator can react to the presentation of the variable.

10. The method of claim 8 wherein presenting the variable using the supervisory controller to the operator of the wind turbine comprises:
displaying the variable on a display;
displaying on the display a first threshold of the variable determined to provide safe operation of the component; and
displayed on the display a second threshold of the variable determined to provide unsafe operation of the component.

11. The method of claim 6 further comprising:
using the first number of the sensor readings to refine a design of the component.

12. The method of claim 6 further comprising:
using the first number of the sensor readings to exclude warranty on the component.

13. The method of claim 6 wherein the sensor is a strain gauge, the component is a rotor blade of the wind turbine, and the sensor readings are related to a change in a strain component experienced by the rotor blade.

14. The method of claim 6 further comprising:
after the first number of the sensor readings is transferred from the buffer to the mass storage device, temporarily storing a second number of the sensor readings communicated from the sensor in the buffer;
comparing the sensor readings received from the sensor with a reference value to detect at least one sensor reading less than the reference value; and
in response to the detection of at least one sensor reading less than the reference value, transferring the second number of the sensor readings from the buffer to the mass storage device for non-volatile storage.

15. The method of claim 14 further comprising:
after the second number of the sensor readings is transferred from the buffer to the mass storage device, temporarily storing a third number of the sensor readings communicated from the sensor in the buffer; and
when the buffer is filled, transferring the third number of the sensor readings from the buffer to the mass storage device for non-volatile storage.

16. A computer program product for collecting sensor readings acquired by a sensor monitoring a component of the wind turbine and communicated to a data collection system, the computer program product comprising:
a computer readable storage medium;
first program instructions for temporarily storing a first number of the sensor readings communicated from the sensor in a buffer of the data collection system;
second program instructions for comparing the sensor readings received from the sensor with a reference value to identify a triggering event for which at least one of the sensor readings exceeds the reference value; and
third program instructions for transferring the first number of the sensor readings from the buffer to a mass storage device of the data collection system for non-volatile storage in response to the identification of the triggering event,
wherein the first, second, and third program instructions are stored on the computer readable storage medium.

17. The computer program product of claim 16 further comprising:
fourth program instructions for using an algorithm executing on the data collection system to compute a variable from the first number of the sensor readings stored in the mass storage device,
wherein the fourth program instructions are stored on the computer readable storage medium.

18. The computer program product of claim 17 further comprising:
fifth program instructions for causing the data collection system to communicate the variable to a supervisory controller,
wherein the fifth program instructions are stored on the computer readable storage medium.

19. The computer program product of claim 16 further comprising:
fifth program instructions for temporarily storing a second number of the sensor readings communicated from the sensor in the buffer after the first number of the sensor readings is transferred from the buffer to the mass storage device;
sixth program instructions for comparing the sensor readings received from the sensor with a reference value to detect at least one sensor reading less than the reference value; and
seventh program instructions for transferring the second number of the sensor readings from the buffer to the mass storage device for non-volatile storage in response to the detection of at least one sensor reading less than the reference value,
wherein the fifth, sixth, and seventh program instructions are stored on the computer readable storage medium.

20. The method of claim 19 further comprising:
eighth program instructions for temporarily storing a third number of the sensor readings communicated from the sensor in the buffer after the second number of the sensor readings is transferred from the buffer to the mass storage device; and
ninth program instructions for transferring the third number of the sensor readings from the buffer to the mass storage device for non-volatile storage when the buffer is filled,
wherein the eighth and ninth program instructions are stored on the computer readable storage medium.
